(19) United States
(12) Patent Application Publication
(10) Pub. No.: US 2003/0235705 A1
(43) Pub. Date: Dec. 25, 2003

(54) Composite magnetic material

(75) Inventors: Ka Wai Eric Cheng, Hong Kong (HK); Chak Yin Tang, Hong Kong (HK); David Ki-Wai Cheng, Hong Kong (HK); Hang Wu, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: The Hong Kong Polytechnic University, Hung Hom (HK)

(21) Appl. No.: 10/177,751

(22) Filed: Jun. 24, 2002

(51) Int. Cl. B32B 25/04

(52) U.S. Cl. 428/492; 428/900

(57) ABSTRACT

A compound for a composite magnetic material having low permeability and low loss magnetic properties includes a polymer resin bonding agent and a filler comprising one or more ferromagnetic materials. The ferromagnetic materials are Cobalt and Nickel particles having an average diameter of less than 100 micrometers. The particles are coated with a titanic coupling agent to facilitate disbursement through the resin and increase the bond strengthen between the particles and the resin.

### Background to the Invention

1. Field of the Invention

The present invention relates to magnetic materials and in particular to a composite magnetic material exhibiting low permeability and losses that is suitable for use in high frequency power conversion.

2. Background Information

Magnetic materials such as ferrites and powered iron are formed into cores for magnetic devices, inductor and transformer cores, for use in, amongst other things, power as converters. Ferrites are mixed compounds of ferromagnetic oxides (Fe₂O₃) and several oxides of bivalent metals such as Nickel Oxide (NiO), Manganous Oxide (MnO) and Zinc Oxide (ZnO). They exhibit low loss and good high frequency operation characteristics. Powdered irons, such as Molydbenum Permalloy Powder (MPP), are mixed with Nickel and Iron to provide magnetic materials for power conversion applications.

The design or a magnetic device depends on such factors as the permeability, loss factor, and size and shape of the core. The loss in a magnetic device usually accounts for 30-40% of the total loss in a power converter.

Conventional magnetic materials suffer from a number of disadvantages including limited size, brittleness, high loss and high cost. One of the typical problems is that for application in high power conversion, over 20 kw, the magnetic materials for device cores are expensive and difficult to form into the desired shape.

### SUMMARY OF THE INVENTION

It is an object of the present invention to provide a magnetic material for use in high frequency power is conversion which is easily formed into magnetic cores and which exhibits low permeability and losses, or which at least ameliorates the above mentioned disadvantages and provides the public with a useful alternative.

According to a first aspect of the invention there is provided a composite magnetic material, having low permeability and magnetic losses, including a polymer base in combination with a metal filler comprising one or more ferromagnetic materials.

Preferably, the metal filler comprises a combination of Cobalt and Nickel particles.

Preferably, the ratio of filler to base agent is 1 to 99 percent by weight.

Preferably, the Cobalt and Nickel particles are coated with a coupling agent.

Preferably, the Cobalt and Nickel particles have a diameter of less than 100 micrometers.

Preferably, the ratio of Nickel to Cobalt is in the range of 10 to 90 percent by weight.

Preferably, the polymer base includes one or more additives.

Preferably, the polymer base is epoxy resin.

According to a second aspect of the invention there is provided a compound, having low permeability and low loss magnetic properties, including

between 36 to 55 percent by weight of a polymer resin bonding agent, and

between 64 and 45 percent by weight of a filler comprising Cobalt and Nickel particles have an average diameter of less than 100 micrometers, and wherein the particles are coated with a titanic coupling agent to facilitate disbursement through the resin and increase the bond strengthen between the particles and the resin.

Further aspects of the invention will become apparent from the following description, which is given by way of example only.

### BRIEF DESCRIPTION OF THE DRAWINGS

Embodiments of the invention will now be described with is reference to the accompanying drawings in which:

FIG. 1 is a toroid made from a composite magnetic material according to the invention,

FIG. 2 of a transformer wound on the toroid of FIG. 1,

FIG. 3 is a B-H curve for the transformer of FIG. 2,

FIG. 4 is a schematic of a flyback converter using a core made from a composite magnetic material according to the invention, and

FIG. 5 illustrates test waveforms for the flyback converter.

### DESCRIPTION OF THE PREFERRED EMBODIMENTS

A composite magnetic material according to the invention is produced by adding a metal powder filler to a polymer base material. In the preferred embodiment the polymer base material (Polymer resin) is a combination of epoxy resin and two additives. The epoxy resin is 4,4- isopropylidenediphend epichlorohydrin resin and the two additives are alkyl glycidyl ether and poly-acrylate ether.

The cross-linking agent (hardener) for the epoxy resin contains diethylenetriamine and 2-hydroxyethydiethylenetriamine. One part of the hardener is mixed with five parts of epoxy resin.

The polymer resin is, thus, a two part mixture. The first part contains the epoxy resin (4,4′isopropylidenediphend epichlorchydrin resin) in the weight range 75%-90% and the two additives, alkyl glycidyl ether in the weight range 5%-20% and poly-acrylate ether in the weight range 10-15%. The second part is the hardener. This is a mixture of the diethylenetriamine in the weight range of 65%-85% and 2-hydroxyethydiethylenetriamine in the weight range of 15%-535%.

The metal powder filler comprises Cobalt particles and Nickel particles. The filler particles should be of suitable size. In the preferred embodiment they are in the range of 1-18 micrometers. Spherical particles are preferred, but other embodiments may use particles in other shapes, such as cubic, or fibrous structures.

The surface of the Cobalt and Nickel particles is treated with a titanic coupling agent to enhance disbursement through the resin and increase the bond strengthen between the particles and resin.

The titanic coupling agent comprises 1.5 percent weight of the filler and has the following structure:

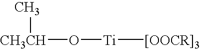

where R is C₁₅H₃₂.

An example of a composite magnetic material comprises 20 grams of the epoxy resin (first part) combined with 4 grams of the hardener (second part). The filler consists of spherical Cobalt particles with diameters in the range of 5-18 micrometers and spherical Nickel particles with diameters in the range of 1-4 micrometers. The surface of the filler particles is been treated by the titanic coupling agent Various quantities of the filler may be added to the resin depending on the magnetic characteristic desired. The following table shows various examples (samples) of compositions of the composite magnetic material.

| | | | | Polymer |
|---|---|---|---|---|
| | | | Filler | Resin |
| | Cobalt | Nickel | weight-to- | weight-to- |
| Example | Particles | Particles | weight | weight |
| (Sample) | (weight, g) | (weight, g) | (%) | (%) |
| 1 | 10 | 10 | 45.0 | 55.0 |
| 2 | 12 | 10 | 47.8 | 52.2 |
| 3 | 14 | 10 | 50.0 | 50.0 |
| 4 | 16 | 10 | 52.0 | 48.0 |
| 5 | 18 | 10 | 54.0 | 46.0 |
| 6 | 20 | 10 | 55.6 | 44.4 |
| 7 | 25 | 10 | 59.3 | 40.7 |
| 8 | 30 | 10 | 62.5 | 37.5 |
| 9 | 32 | 10 | 63.6 | 36.4 |

In order to avoid the formation of air bubbles, the blending process of the fillers and the resin is done in a vacuum. Otherwise, the composite will become porous and its electromagnetic properties will be deteriorated. After blending, the resultant resin is moulded and cured at room temperature for 30 minutes until solidification.

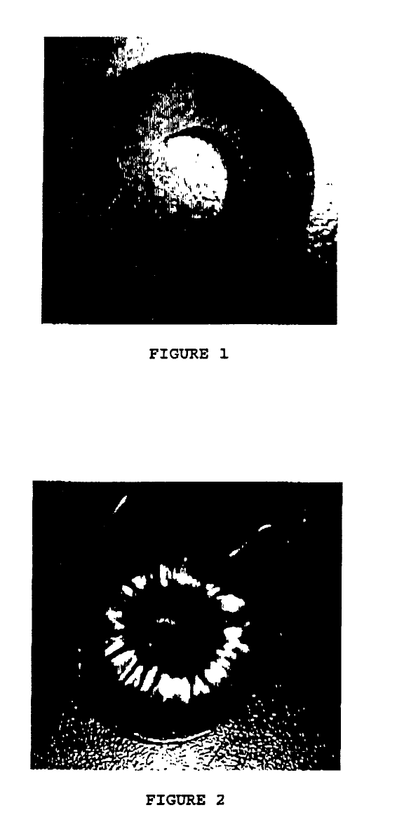

Referring to FIG. 1 there shown is a toroid made from the composite magnetic material with the quantities of example 7 above. The toroid has outer and inner diameters of 1-7/16 inches (37mmm) and 10/16 inches (16mm) respectively, and a height of 10/16 inches (16mm) The weight of the core is about 15 grams. The core is stronger and less brittle than an equivalent ferrite or powdered iron core.

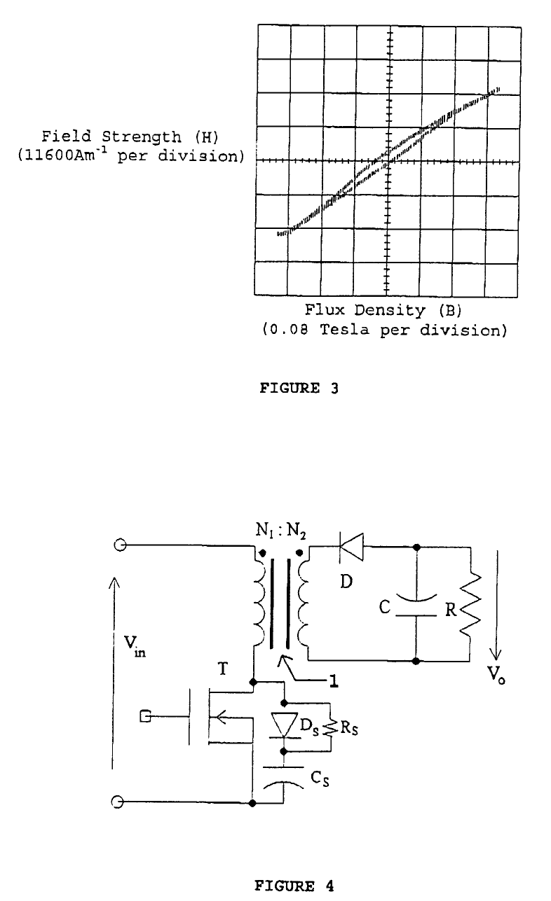

Referring to FIG. 2, to test the characteristics of the core made from the composite magnetic material it is wounded with 500 turns. The core was tested at 400Hz in known manner. FIG. 3 is a B-H curve for the wound core.

The core has a very high saturation point. At a magnetic field strength (H) of 40 kA/m the flux density (B) is only 0.18T. The core has a low relative permeability of 3.6. The hysteresis loss is 725J/m³.

Low permeability cores made from the composite material are ideally suited to use in high frequency power conversion. The low permeability also results in better confinement of the leakage field than that of an air-core.

In this example, the relative permeabilities of different compositions ratios of Cobalt particles (Co) and Nickel (Ni) in the filler are listed in the following table. The quantities correspond to those of the Examples give in the previous table.

| | Cobalt | Nickel | Relative |
|---|---|---|---|
| Example | particles | particles | permeability, |
| (Sample) | (grams) | (grams) | μᵣ |
| 2 | 12 | 10 | 1.63 |
| 4 | 16 | 10 | 1.73 |
| 6 | 20 | 10 | 2.71 |
| 7 | 25 | 10 | 3.20 |
| 9 | 32 | 10 | 3.65 |

For these compositions the loss varied between 500 J/m³ and 40J/m³ with a peak flux density of ±0.2T.

The composite magnetic compound has other advantages over known core materials including ease of forming. Such known methods as injection moulding can be used which provide savings in manufacturing costs and quality control. Shapes can be obtained which would otherwise require special tools to press and form cores of ferrite or powdered iron.

Desirable characteristics of the composite magnetic material include thermal stability, low environmental deterioration, high mechanical strength and excellent magnetic and electrical properties. Because the polymer is a non-conductive material eddy currents are decreased resulting in the improved efficiency.

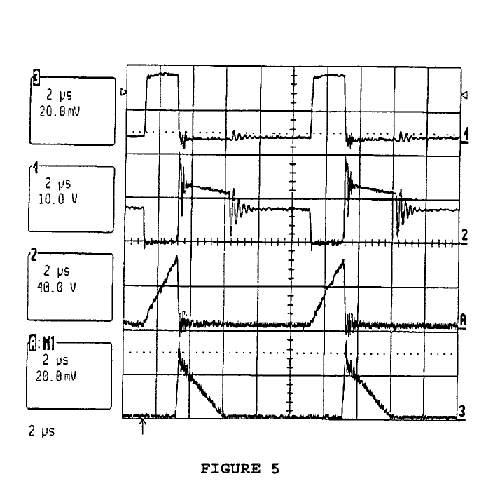

Referring to FIG. 4, a flyback converter includes a 1:1 transformer (usually called coupled inductor for the flyback converter), reference numeral 1, made of the composite magnetic material. Other components of the converter are given in the following table.

| Components | Parameters | | Remark |
|---|---|---|---|
| Ni | 50 | | Primary turns |
| T | IRF540 | | Switching |
| D | MUR820 | | Rectifier |
| C | 33 | μF | Smoothing |
| Rs | 1 | kΩ | Snubber |
| Cs | 0.03 | μF | Snubber |

| | | |
|---|---|---|
| Ds | MUR820 | Snubber |

The electrical specification of the flyback converter is:

| Operation | Specification | |
|---|---|---|
| Input voltage Vin | 25-30 | V |
| Output voltage Vo | 15-20 | V |
| Output power Po | 0-30 | W |
| Switching frequency | 100 | kHz |
| fs | | |

The flyback converter was tested using a duty ratio of 0.2 and an input voltage of 30V. The resulting waveforms are illustrated in FIG. 5. The converter operated in discontinuous inductor conduction mode. An RCD snubber was added to the switching devices T because the switching noise was especially serious with the converter in discontinuous mode.

The efficiency of the converter was around 68-80% with the output power varied between 5W-30W. The inductor current was very linear because the core 1 did not saturate. Operation of the converter was normal confirming that the polymer-bonded conposite magnetic material is suitable for use in power converters.

Where in the foregoing description reference has been made to integers or elements having known equivalents then such are included as if individually set forth herein.

Embodiments or the invention have been described, however it is understood that variations, improvements or modifications can take place without departure from the spirit of the invention or scope of the appended claims.

What is claimed is:

1. A composite magnetic material, having low permeability and magnetic losses, including a polymer base in combination with a metal filler comprising one or more ferromagnetic materials.

2. A composite magnetic material as claimed in claim 1 wherein the metal filler comprises a combination of Cobalt and Nickel particles.

3. A composite magnetic material as claimed in claim 1 wherein the ratio of filler to base agent is 1 to 99 percent by weight.

4. A composite magnetic material as claimed in claim 2 wherein the Cobalt and Nickel particles are coated with a coupling agent.

5. A composite magnetic material as claimed in claim 2 wherein the Cobalt and Nickel particles have a diameter of less than 100 micrometers.

6. A composite magnetic material as claimed in claim 2 wherein the ratio of Nickel to Cobalt is in the range of 10 to 90 percent by weight.

7. A composite magnetic material as claimed in claim 1 wherein the polymer base includes one or more additives.

8. A composite magnetic material as claimed in claim 1 wherein the polymer base is epoxy resin.

9. A compound, having low permeability and low loss magnetic properties, including
between 36 to 55 percent by weight of a polymer resin bonding agent, and
between 64 and 45 percent by weight of a filler comprising Cobalt and Nickel particles have an average diameter of less than 100 micrometers, and wherein the particles are coated with a titanic coupling agent to facilitate disbursement through the resin and increase the bond strengthen between the particles and the resin.
